(19) United States
(12) Patent Application Publication
(10) Pub. No.: US 2015/0014286 A1
(43) Pub. Date: Jan. 15, 2015

(54) CO2 LASER WITH RAPID POWER CONTROL

(71) Applicant: IAI INDUSTRIAL SYSTEMS B.V., Veldhoven (NL)

(72) Inventor: Gisbert Staupendahl, Kunitz (DE)

(21) Appl. No.: 14/376,298

(22) PCT Filed: Jan. 31, 2013
(86) PCT No.: PCT/DE2013/000069

§ 371 Date: Aug. 1, 2014

(30) Foreign Application Priority Data
Feb. 3, 2012 (DE) 102012002470.3

(51) Int. Cl. H01S 3/22; B23K 26/06; B23K 26/067; H01S 3/10

(52) U.S. Cl. CPC H01S 3/22; H01S 3/10061; B23K 26/0626; B23K 26/067
USPC 219/121.61; 372/55; 219/121.77

(57) ABSTRACT

Subject matter of the invention is a CO₂ laser that permits a rapid power modulation, particularly a highly efficient Q-switching. The key concept is the sub-division of the resonator into a high-power branch, containing inter alia the active medium (1), and a low-power feedback branch (14), in which the power-sensitive beam-shaping elements, particularly the modulators, are arranged. This is made possible by a suitable arrangement of a polarisation beam splitter (5) and a λ/4-phase shifter (2). The free adjustability of an angle φ between said two components permits the extremely flexible realisation of various operating modes, particularly the optimisation of the feedback degree during pulse generation.

### BACKGROUND OF THE INVENTION

For finishing (precision machining) different materials with lasers, in by far the largest number of applications pulsed radiation is used. This applies to all typical laser material processing lasers likewise. Applications are, for example, cutting, drilling and defined material removal of metals, ceramics, plastics, etc.

Modern solid-state laser systems (diode-pumped Nd:YAG lasers, disc lasers, fibre lasers, Ti:sapphire lasers, etc.) are characterised by a pulsability being variable in a wide range (from 100 fs via ps and ns to the μs range), but in terms of cost and especially long-term experience in industrial use they are still far behind the CO₂ lasers. However, a significant basic disadvantage of all previously available commercial CO₂ lasers suitable for material processing is their limitedly rapid power control and thus their limited pulsability. Limits mainly exist when it is intended, for CO₂ high-power lasers having, for example, cw output power in the kW range, to transform this power as effectively as possible into pulsed radiation. As before, there is now no commercial CO₂ laser available that delivers pulsed radiation at high average power with pulses having quasi-Q-switched properties, i.e. power increases of at least a factor of 10 compared to the cw power with pulse lengths in the ns and μs region, with additional requirements having to be met, namely that for most CO₂ lasers, a typical relatively good beam quality K value (at least 0.6) has to be maintained, and that an effective transformation of the potentially available power (cw) into average power of the pulsed system can be achieved.

Equipping a material processing system with such a CO₂ laser would mean a big technological progress under several aspects:

a) The applications implemented up to now with the CO₂ laser could be performed even more efficiently.

b) Numerous applications reserved up to now to other laser types (e.g. precision drilling and cutting of copper and aluminium and other metals, the processing of which is associated with special pulse parameters—for instance titanium is mentioned here) or completely new applications could be implemented with such a CO₂ laser.

c) The flexibility of the system would be extremely high, since the most various tasks could be processed that under the present technical conditions would be associated with different laser types. Here again can be mentioned the overall efficiency when manufacturing e.g. a complicated component with fine boreholes, complicated cutting contours and the like. Equally relevant is the possible fast change of the material type, e.g. from metal to ceramics.

The prior art can be summarised as follows.

Due to the very good storage properties of its active medium, the CO₂ laser is suitable for most various kinds of Q-switching with power increases by a factor 100 and more. Therefore, in the first two decades already of its fast development of active Q-switching by means of simple rotary mirrors and the electro- and acousto-optic modulation up to passive Q-switching by means of SF₆ and even mode locking in CO₂ TEA lasers (see W. J. Witteman, “The CO₂ Laser”, Springer-Verlag 1987), countless variants have been investigated. A comprehensive survey can be found e.g. in: SPIE Milestone Series Vol. MS 22, “Selected Papers on CO₂ Lasers”, ed. by James D. Evans, SPIE 1990. Based on this fact, at first glance, it seems to be surprising that practically none of these methods has been widely applied in CO₂ lasers for material processing. They remained just an interesting subject of basic research up to huge systems for investigations of laser-controlled nuclear fusion, but did not play a relevant role in industrial applications.

In contrast, the simple, however functional and low-cost method of pulsing of CO₂ lasers by gas discharge has won out, which is employed in practically every material processing laser, although it has serious weaknesses such as low power increase for the generated pulses, relatively long pulse durations and low pulse repetition frequencies. Therefore, the short pulse range (μs and lower) being important for countless applications is occupied nearly exclusively by the above solid-state laser systems. This is caused less by the amplification properties of the active medium, but rather by the wavelengths. While, in the visible and near infrared ranges around 1 μm, there are numerous excellently suitable optical materials, e.g. crystals or glasses, which are characterised, inter alia, by low absorption, high radiation loading capacity, large electro- and elasto-optic constants and excellent possibilities for processing and coating, the material spectrum at wavelengths of about 10 μm is rather limited, in particular when special properties are involved, such as the electro-optic effect that is practically limited to CdTe, or when good acousto-optic properties are involved that only Ge has in the desired kind. A general problem is the limited radiation loading capacity, and this does not primarily mean the destruction of the component by too high intensities, but the optical effects occurring way before the destruction threshold and in particular associated with the relatively high dn/dT ratio (change in refractive index per change in temperature) of these materials, these effects leading to deformations of the wave front and being mainly unacceptable for applications within the laser resonator, i.e. e.g. for Q-switching, since they result in a beam quality of the laser being strongly dependent on the power.

A promising approach for an optimum transformation of the power being potentially available in a CO₂ laser into intense radiation pulses was provided by coupling-out modulation by means of an interference output coupler element (see Schindler, K.; Staupen-dahl, G.: “Ein neuartiger CO₂-Impulslaser für die Materialbearbeitung”, yearbook LASER (3^{rd} edition), ed. H. Kohler, Vulkan-Verlag 1993, p. 9-14, and German Democratic Republic patent WP H 01 S/286 072 5 (1986) “Anordnung zur Wellenlängenselektion and internen Leistungsmodulation der Strahlung von Hochleistungs-CO₂-Lasern”). Here, too, an industrial-suited implementation in the range of higher average powers failed, however, due to the power sensitivity of the decisive component, the interference output coupler element.

Due to the high relevance for practical applications, the implementation of optimally pulsed CO₂ lasers continues to be an important object of laser development, so that in the recent decade patent specifications with respect to these problems have again been published. In the U.S. Pat. No. 6,826,204, e.g., a pulsed CO₂ laser for material processing comprising an electro-optic CdTe Q-switch is described. For the basic problem of the possibly low radiation loading capacity of the Q-switch at as high as possible average laser output powers that are particularly important for an efficient material processing, no solution is proposed in the patent specification.

Similar considerations apply to a following specification by the same applicant, the U.S. Pat. No. 7,058,093. Herein, the principle of electro-optic Q-switching by means of a CdTe modulator is associated with the principle of a special power extraction, the cavity dumping. It is the object here to generate pulse trains with an as high as possible increase of the peak pulse power relatively to the cw power of the laser simultaneously with a very high pulse repetition frequency. The problem of the radiation loading capacity is solved here either.

Due to the substantially better optical properties of Ge compared to CdTe, Q-switching of CO₂ lasers by means of acousto-optic modulators based on Ge is also of interest. In the DE 112008001338 T5, such a laser is described. The patent specification does not propose any special measures in the design of the resonator for implementing high average output powers together with good beam quality.

### SUMMARY OF THE INVENTION

It is the object of the system according to the invention to modify CO₂ lasers of conventional design, in particular lasers that are used for material processing, such as slow or fast axial flow systems, however also those with a stationary gas filling, such that completely new possibilities of rapid power control, particularly the generation of radiation pulses, will result, which are characterised by a very wide range of parameters, in particular on the one hand the time control down to the ns range, and on the other hand a power range, which for peak pulse powers will come into the magnitude order of 100 kW and for the average power into the kW range.

This object is achieved by the subject matters of the patent claims.

If in the claims a straight line or a bent line course of the resonator axis is mentioned, this relates to the geometric centre line in the longitudinal extension of the laser. This is not to be confused with the optical path, for a beam through the polarisation beam splitter travels only then not in a bent line, when both its main faces are exactly perpendicular to the beam. When the polarisation beam splitter is oblique relative to the (passing) beam, a double bend of the beam will occur, with the beam paths on both sides (exit and entry) being parallel to one another.

In detail, there are different possibilities of implementation, and these will be described in the following as not-limiting variants, and some or all features that technically reasonably can be combined with each other, can be combined with each other.

Thus, the invention is also achieved with a CO₂ laser having an active medium in the low or medium pressure range up to maximum approx. 0.1 bar, so that cw operation is possible by corresponding supply of pump energy, and having a resonator that is modified with respect to conventional CO₂ laser resonators, which are characterised by a highly reflecting end mirror at the one end and an output coupler element at the other end of the active medium, said modified resonator being characterised by that that between the one end of the active medium and a first resonator end mirror of high reflectivity, which preferably is larger than 99%, a λ/4-phase shifter is disposed, and between the other end of the active medium and a second resonator end mirror of high reflectivity, which preferably is also larger than 99%, a polarisation beam splitter is disposed, and that the polarisation beam splitter sub-divides a beam incident from the active medium and having an arbitrary polarisation into a linearly polarised beam to be coupled out and having the power P_{A} and a beam to be fed back and having the power P_{R} and also having linear polarisation, however in a direction perpendicular to the polarisation of the beam to be coupled out, wherein the λ/4-phase shifter or the polarisation beam splitter or both are arranged to be turned with respect to the resonator axis, so that by adjustment of a freely selectable angle φ between a characteristic axis of the λ/4-phase shifter perpendicular to the resonator axis, and a characteristic axis of the polarisation beam splitter also perpendicular to the resonator axis, an arbitrary desired power ratio P_{A}/P_{R} can be adjusted, and that between the polarisation beam splitter and the second resonator end mirror, i.e. in the feedback branch of the resonator, elements for beam-shaping, in particular elements for rapid power modulation and for wavelength selection as well as special apertures can be disposed.

The active medium can exclusively be provided in the zone between the first resonator end mirror and the polarisation beam splitter. Then, this zone is sealed by gas-tight walls from other zones of the laser and from the environment (with the exception of gas supply and/or gas discharge lines).

The electrodes are typically electric electrodes.

The polarisation beam splitter may be a thin-film polariser based on ZnSe that is disposed at Brewster's angle α_{B} to the resonator axis 11.

In the feedback branch of the resonator, elements for (preferably rapid) power modulation, preferably electro-optic or acousto-optic modulators, interference laser radiation modulators, mechanical choppers or (preferably rapid) tilting mirrors may be disposed.

In the feedback branch of the resonator, an electro-optic modulator as well as, between the latter and the polarisation beam splitter, a telescope, preferably a Galileo's-type telescope, for adjusting the beam diameter D to the free opening d of the electro-optic modulator may be disposed, with the ratio D/d preferably being between 1.2 and 5, and an absorber (26) intercepts the returning beam with its polarisation being rotated by 90° when a λ/4-wave voltage is applied to the electro-optic modulator, said beam being deflected by the polarisation beam splitter from the optical path in the resonator.

In the feedback branch of the resonator, an acousto-optic modulator as well as, between the latter and the polarisation beam splitter, a telescope, preferably a Galileo's-type telescope, for adjusting the beam diameter D to the free opening d of the acousto-optic modulator may be disposed, the ratio D/d preferably being between 1.2 and 5, and two absorbers intercept the beam portions, which are deflected by the polarisation beam splitter from the optical path in the resonator, when a switching voltage is applied to the acousto-optic modulator.

The beam being deflected when a switching voltage is applied to the acousto-optic modulator can be reflected by the second resonator end mirror and can be used as the beam to be fed back, and the not deflected beam portion can be destroyed by an absorber, between the telescope and the acousto-optic modulator optionally a special aperture being provided for assuring the optimum beam quality.

In the feedback branch of the resonator, first, an interference laser radiation modulator may be disposed at a small angle ε of its optical axis to direction of the beam to be fed back, such that the radiation portions reflected by it are deflected from the optical path in the resonator and are intercepted by absorbers, and second, a wavelength-selective element assures the function of the laser at exactly one wavelength.

In the feedback branch of the resonator, optionally prisms, preferably Brewster's double prisms of ZnSe or NaCl, or interference filters may be employed as wavelength-selective elements.

In the feedback branch of the resonator, a Keplerian-type telescope with an intermediate focus may be arranged, and a chopper disc with a drive element may be disposed such that the beam to be fed back is blocked or becomes free by the chopper disc exactly in this intermediate focus.

The second resonator end mirror may be a preferably rapid tilting mirror, and between the latter and the polarisation beam splitter, optionally a telescope, preferably a Galileo's-type telescope, may be disposed for adjusting the beam diameter D to the free opening d of the rapid tilting mirror, the ratio D/d preferably being between 1.2 and 10.

The optionally employed elements for adjusting the beam diameter D to the free openings d of the elements for power modulation may either be Galileo's-type or Keplerian-type telescopes in a lens design or Galileo's-type or Keplerian-type telescopes in a mirror design or combinations of such a collector lens or a collector mirror, respectively, having a second resonator end mirror with a suitable curvature.

By means of the optionally employed wavelength-selective elements, the laser can be forced to operate on a firm, but freely selectable line of the rotational-vibrational spectrum of the CO₂ laser in the range 9 μm<λ<11 μm, with the properties of the remaining optical elements of the laser, in particular of the λ/4-phase shifter and of the polarisation beam splitter, being adjusted to this selected line.

All mentioned optical elements can be accommodated in a common vacuum-tight housing, and the beam to be coupled out leaves the laser through a window of a transparent material, preferably ZnSe.

In a material processing system according to the invention, an interference laser radiation modulator may be integrated in the beam path between the laser output and the workpiece with the proviso that the transmitted beam travels as a power-controlled beam toward the workpiece, and the reflected beam is optionally fed to an absorber/detector for destruction or for on-line measurement. In the beam path between the laser output and the workpiece, an acousto-optic modulator may be integrated with the proviso that the deflected beam travels as a power-controlled beam toward the workpiece (33), while the not deflected beam is optionally fed to an absorber/detector for destruction or for on-line measurement, optionally between the polarisation beam splitter and the acousto-optic modulator elements for beam-shaping, e.g. a telescope and/or a special aperture, being disposed.

The basic idea of the solution according to the invention is to modify the conventionally employed basic structure of the laser resonator with a 100% mirror at the one end and the output coupler element at the other end of the system such that the resonator is sub-divided into a high-power branch that is formed inter alia by the active medium and a special output coupler element, and into a low-power feedback branch that includes inter alia the elements for rapid power control. The power ratios between high- and low-power branches may be varied in a wide range by the following system variants, so that for controlling even very high powers only a small portion thereof, e.g. 10%, is required. Thus, all modulator systems existing for the CO₂ laser technology, however being relatively power-sensitive, e.g. acousto-optic, electro-optic, or interference laser radiation modulators, can be used for rapid power control, in particular for an efficient Q-switching.

The novel resonator arrangement according to the invention is now described in detail (cf. also FIG. 1).

The central element for the sub-division of the resonator into a high-power branch and a low-power-feedback branch is a polarisation beam splitter. In the case of the CO₂ laser, a thin-film polariser (TFP) based on ZnSe can be used for this purpose. The latter is characterised by that the TFP is placed at Brewster's angle α_{B} in the optical path, and due to the special coating, an incident radiation beam having the power P₀ is sub-divided such that its portion being polarised in parallel to the plane of incidence of the TFP-polarised portion and having the power P_{P} is fully transmitted, and its portion being polarised perpendicular to the plane of incidence and having the power P_{S} is fully reflected, i.e.

P₀=P_{P}+P_{S},

wherein losses, e.g. by absorption in the TFP, were neglected.

The TFP is positioned approximately at the location of the output coupler mirror in other contexts being conventional and also serves, in the laser according to the invention, as an output coupler element, i.e. either the beam reflected at the TFP or the transmitted beam is coupled out and leaves the resonator. The respectively other partial beam is used for resonator feedback, which can be achieved, e.g., by an adjustable 100% mirror that sends the beam back exactly in itself. The beam path between this mirror and the TFP forms the mentioned low-power feedback branch, in which arbitrary elements for power control of the laser may be disposed.

A second central idea of the invention deals with the problem, how the power ratio P_{P}/P_{S} can be adjusted in an optimum and as flexible as possible manner, so that the respective laser modified according to the invention can be adjusted according to its basic properties, in particular its power, the gain of its active medium, and according to the respective object of the novel parameters to be achieved, in particular of special pulse parameters. This is achieved by aimed influencing of the polarisation properties of the radiation generated in the laser, by that “at the other end” of the resonator, ahead of the existing end mirror with approx. 100% reflectivity, a component with a phase shift of λ/4 per passage is disposed. For high-power CO₂ lasers, λ/4-phase retarder mirrors (PRS) proven in the field of laser material processing will be employed. With a corresponding geometric arrangement, this component transforms linearly polarised radiation after one passage into circularly polarised radiation. If the latter is now reflected at the first end mirror 51 and travels a second time through the λ/4-phase shifter, the circularly polarised radiation is transformed back into linearly polarised radiation, however rotated by 90° relative to the original direction.

The mentioned properties of the TFP and of the λ/4-phase shifter and the arrangement thereof according to the invention in the resonator permit a series of novel options of the laser function that are explained in detail below.

1. The Quasi-Axial-Mode-Free Continuously Operating Laser.

Let us begin with the TFP and assume that an arbitrarily polarised radiation beam falls from the resonator interior, i.e. from the active medium, upon the TFP. Here, the mentioned sub-division into transmitted and reflected beams takes place, which are then both polarised linearly and in directions perpendicular to each other. In principle, each of these two beams can be coupled out as a laser beam, and the respectively other one can be used as a feedback beam. Inter alia due to the strong wavelength dependence of the properties of commercially available TFPs based on ZnSe which will be discussed in more detail in the embodiments, it is reasonable to couple out the reflected beam and to feed back the transmitted beam, so that the following considerations are based on this option.

First, the laser is operated without any additional elements for power modulation, i.e. the beam transmitted at the TFP falls directly upon the second 100% end mirror S2, is reflected back there exactly in itself, passes a second time (practically without losses) the TFP, and is then amplified in the active medium, with its direction of the linear polarisation given by the position the TFP being maintained. After passage of the active medium, the beam reaches the combination of λ/4-phase shifter and S1 and would again, with a corresponding precise adjustment of the phase shifter, be linearly polarised, but rotated by 90° relative to the incident beam, and passes again the active medium, now in the opposite direction. At this point, a serious difference between conventional lasers and the laser according to the invention is encountered: In the conventional lasers, the waves travelling back and forth in the active medium typically are linearly polarised in the same direction, i.e. they are fully capable of interference, which will lead to the known axial mode structure. In the laser according to the invention, the two waves are also linearly polarised, however in directions perpendicular to each other, so that no interference and thus no axial mode structure will occur.

For material processing lasers, the axial mode structure is in most cases less important, which is however not a priori justified. Since it is very sensitively (μm range) coupled with the resonator length, temperature changes in the order of 10⁻²° C. are already sufficient, with the relatively large resonator lengths of CO₂ material processing lasers, to change the axial mode structure in a relevant manner. By averaging effects, this will in most cases not be observed, but with highest precision requirements it is found that power as well as spatial direction variations of the radiation beam may result. Another problem caused by the axial modes, i.e. the standing waves in the resonator, is the so-called “spatial hole burning”, which particularly in solid-state lasers reduces the output power of the laser. The reason for this is the periodical intensity variation of the standing wave between 0 and a maximum value with the period λ/2, which will lead to an incomplete query of the population inversion via stimu-lated emission. In a laser without axial mode structure, these negative effects will not occur.

Now let us follow again the path of the radiation beam in the resonator. After the second passage through the active medium, it will arrive again at the TFP with the fatal effect that under the conditions assumed up to now and explained above, practically 100% of the beam is reflected, i.e. there is no feedback, the laser process stops. This very special situation representing a specificity of the laser according to the invention, will be discussed in more detail further below in the 3^{rd} option, the so-called “self-oscillation”.

In order to achieve the feedback required for a “normal” laser function, continuous as well as pulsed, the laser according to the invention offers a very simple and at the same time flexible possibility to adjust a defined feedback. The λ/4-phase shifter is arranged rotatably about its beam axis, which is in this case the axis of the beam incident thereonto from the direction of the active medium. Depending on how far now the phase shifter is turned away from its “ideal” position, not a linear, but rather a more or less elliptically polarised beam travels back toward the TFP with the consequence that then a certain, precisely adjustable portion is transmitted by the TFP and is available as a fed-back beam. This portion is made on the one hand as large as necessary, in order to achieve a safe laser function with an as optimum as possible query of the population inversion of the active medium, is on the other hand however held as small as possible, so that the described advantages of the arrangement according to the invention do not get lost, namely on the one hand the as low as possible radiation intensity in the feedback branch and on the other hand the quasi-axial-mode-free operation of the laser.

At this point it may be required, depending on the desired kind of operation and the power class of the laser, due to the dependence between laser output power and the feedback degree, to make a compromise. If it is desired that the laser operates in particular in continuous operation with optimum output power, higher feedback degrees are required than e.g. for the pulsed (Q-switched) operation described further below. However, for the CO₂ lasers discussed here for material processing with a typical power range of several 100 to several 1,000 W, feedback degrees between 5 and 20% are already sufficient, with relatively low losses of cw power, so that the above requirement of an as low as possible intensity in the feedback branch can also be well met in the cw operation.

2. The Quasi-Axial-Mode-Free Q-Switched Laser.

Main areas of use of the CO₂ laser according to the invention are applications that require rapid power control, in particular the generation of defined radiation pulses by means of Q-switching. The necessary elements are arranged in the feedback branch that is characterised by low intensities. In contrast to conventional CO₂ lasers, all typical modulation variants available for 10 μm wavelengths can be used here that are generally relatively sensitive to high intensities and that, when e.g. directly arranged in high power resonators, will either critically affect the beam quality or even be destroyed. In the following, five variants of such a power control will be discussed: electro-optic and acousto-optic modulators, interference laser radiation modulators, the simple chopper disc and rapidly oscillating tilting mirrors.

### a) Use of Electro-Optic Modulators (EOM).

Using the linear electro-optic effect (Pockels effect) for the resonator-internal power control of lasers is mainly characterised by the extremely short achievable switching times going down to the sub-ns range, i.e. by an extremely good suitability for Q-switching of lasers, and furthermore by a very high flexibility with respect to the switching parameters such as rise times or pulse repetition frequency. While in the visible and near infrared spectral range numerous very well suitable crystals for electro-optic switches exist, this option is limited, in the wavelength range of the CO₂ laser, practically exclusively to commercially available CdTe modulators. By their optical properties being, compared e.g. to ZnSe, substantially less favourable, in particular their comparatively high absorption, these modulators can however only be employed for relatively low intensities. The laser according to the invention offers, by its special feedback branch, with its intensity being reduced approximately by one magnitude order relative to the conventional laser resonator (with the same laser output power!), an advantageous option. Another extremely favourable specialty of the novel arrangement is the fact that the polarisation-sensitive element (the analyser), which in conventional resonators has additionally to be integrated for effecting the modulation of the EOM, is already immanently present in the resonator according to the invention in the form of the TFP. Due to the relatively small cross-section of CdTe EOM, which is generally smaller than the typical beam cross-section of a high-power CO₂ laser, however, in most cases an adjustment of the beam diameter is required, e.g. with the aid of a telescope.

The switching or modulation function then proceeds simply as follows. The beam travelling from the TFP into the feedback branch, said beam being polarised linearly and in parallel to the plane of incidence of the TFP, travels through the beam-shaping element (telescope) and the voltage-free EOM and is reflected by the 100% mirror, and with optimum adjustment of the mentioned elements the beam travelling back into the active medium has the same spreading properties (divergence) and the same polarisation as the incident beam, so that a quasi-ideal resonator function (transversal mode structure!) is assured, i.e. the laser operates with optimum power. When now a λ/4 voltage is applied to the EOM, which converts the linearly polarised beam into a circularly polarised beam, the latter will, after reflection at the 100% mirror and after the second passage of the EOM, be again linearly polarised, but now perpendicularly to the incident beam. When this beam reaches the TFP, it will be reflected completely out of the optical path in the resonator and will be intercepted by an absorber, i.e. the feedback is virtually zero. The generation of radiation will stop at that moment, when the resonator losses generated thereby are so large that the system is below the “laser threshold”. It is emphasised again that in this way a laser power is switched that is approximately by one magnitude order above the power in the feedback branch! The achievable minimum switching times are determined by the properties of the EOM itself and by the manner of control thereof as well as by the resonator length and are typically in the magnitude order of ns.

### b) Use of Acousto-Optic Modulators (AOM).

Conventionally, modulators based on the acousto-optic effect for CO₂ lasers are made from Ge crystals. These are, same as CdTe, clearly limited with respect to their admissible power density that is determined by the requirement that the optical path in the resonator needs to be uninfluenced even with changing loads, e.g. when the laser power is varied. 100 W/cm² should not be exceeded. Here, too, the principle of the laser according to the invention offers the solution. Since AOMs, quite analogously to EOMs, are limited with respect to their free opening, the basic structure will be similar to the one described in a), i.e. a telescope is employed, and instead of the EOM the AOM is used. In a typical case, the free laser function is again obtained for the voltage-free AOM. Switching the laser off, i.e. reducing the feedback below the threshold, is achieved by activating the AOM, so that when passing it two times, each time so much radiation is deflected from the feedback branch and intercepted by absorbers that the laser function stops. In the embodiments is also described the second possibility, where the deflected beam is used for feedback.

The achievable switching times are in the is range and below, i.e. by AOMs, too, modulation frequencies in the MHz range can be implemented. Advantages of the AOM use are inter alia the higher robustness and the optical homogeneity of Ge compared to CdTe, the lower switching voltages required as well as the lower cost.

### c) Use of Interference Laser Radiation Modulators (ILM).

Modulators of this type are based on the principle of the Fabry-Perot interferometer (FPI) and are typically equipped with two ZnSe plates as optically effective elements. Due to the very favourable properties of ZnSe and its large range of use in the CO₂ laser technology, ILMs offer the advantage that, on the one hand, they can be adjusted without problems to the resonator-internal beam diameter, so that generally no additional telescopes are required, and on the other hand, the radiation loading capacity is substantially higher than for CdTe and Ge. Thereby, by such modulators, multi-kW lasers of the type according to the invention can also be switched.

ILMs operate as variable beam splitters, i.e. the incident laser power is sub-divided in a practically loss-free manner into a transmitted and a reflected beam, and the splitting ratio can be varied in a very flexible manner, however only in the kHz range, by a corresponding controller. Since an ILM achieves a transmission maximum of the value 1, it is arranged in the optical path (at a similar position as the EOM and AOM) such that this corresponds to the condition of full laser function. The more it is adjusted now by means of a control current toward increasing reflection, the more the resonator losses will increase, since the reflected portions are deflected from the feedback optical path due to a small inclination of the ILM axis with respect to the resonator axis, and are destroyed by absorbers. When the losses are lowered again below the laser threshold, the laser function will stop. Typical achievable switching or pulse parameters of this variant are switching times and pulse durations in the us range as well as pulse repetition frequencies up to the order of 10⁴ Hz. Since modulators of the ILM type can be loaded with up to several 100 W, average laser output powers of several kW are achievable.

### d) Use of Mechanical Switches.

For Q-switching of the laser according to the invention, simple mechanical switches, in particular rotating pinhole or slit apertures or rapidly oscillating tilting mirrors, can also advantageously be employed. E.g., a Keplerian-type telescope having a sharp intermediate focus can be integrated in the feedback branch, and at the position of this focus, switching operations in short times in the us range can be performed by means of a rapidly rotating pinhole or slotted disc. Depending on the number and arrangement of the free openings on the disc and the rotational speed thereof, a very efficient transformation of the available average power of the laser into pulses with a strong power increase at pulse repetition frequencies up to several 10 kHz and typical pulse durations in the us range can be achieved. Here, too, the low radiation intensity in the feedback branch is favourable: When generating pulses having high power, the switching edges of the rotating disc are exposed to high intensities, which with conventional lasers may lead to ablation processes and thus to a relatively quick destruction of the sharp switching edges, whereas this is avoided in the laser according to the invention.

In the embodiments is also described a variant with a rapidly oscillating tilting mirror.

### 3. The Self-Oscillation.

As already indicated above, the laser according to the invention shows, due to its special resonator structure, a very specific kind of operation—the self-oscillation. This novel effect will be explained in the following in more detail. The basis for the occurrence of the self-oscillation is the precise adjustment of the two elements being characteristic for the described laser, the λ/4-phase shifter at the one end of the resonator and the TFP at the other end, and, if necessary, a wavelength-selective element has to secure that the laser operates at an exactly defined wavelength corresponding to the specifics of phase shifter and TFP. “Precise adjustment” means that the planes of incidence of the λ/4-phase shifter (if it is assumed that it is a conventional PRS) and of the TFP are rotated with respect to one another by exactly 45°. The two 100% end mirrors of the resonator have also to be precisely adjusted in the usual way.

For qualitatively understanding the occurring processes after switching the laser on, it is assumed that the population inversion in the active medium has reached a quasi-balanced condition, and now it is observed, how a starting radiation beam, which at the beginning exclusively consists of spontaneously emitted photons that randomly travel exactly in the direction of the laser axis, behaves on the way of further propagation in the resonator. The effect is most clearly seen, if it assumed that this starting radiation beam starts at the end of the active medium, which is close to the TFP, and moves toward the interior of the active medium, i.e. toward the λ/4-phase shifter. On the way thereto the beam is amplified, its unpolarised condition that is typical for the spontaneously emitted starting radiation beam, is practically maintained. This is not changed on the path phase shifter-100% end mirror-phase shifter, since here all radiation portions are rotated in the same way by 90°, i.e. the beam remains unpolarised. After another amplification on the second passage through the active medium, it will now hit on the TFP and is split there essentially into two identically strong partial beams, which are linearly polarised, however in directions perpendicular to each other. One of them is coupled out, the other one is fed back. The latter travels now again toward the λ/4-phase shifter through the active medium, its properties are however significantly modified relative to the starting radiation beam: First, it is linearly polarised, and second, it already has a substantially higher power by induced emission. On the second “round trip” through the resonator, it is further amplified and—which is the decisive factor for the self-oscillation—during the double passage through the λ/4-phase shifter, its direction of polarisation is rotated by 90°, so that it is now completely coupled out when it reaches the TFP, i.e. feedback is 0. Thus, the further amplification by induced emission breaks down, the output power of the laser is practically 0 for a short time, before a new cycle starts in the explained manner. From the qualitative description of the process it is clear that the laser output power is respectively maximum, when the beam has completed two tours, i.e. the path 4L (L is the resonator length). Therefrom follows a pulse repetition frequency fᵢₘₚ of

fᵢₘₚ=c/4L,

where c is the speed of light. For typical resonator lengths of several meters, pulse repetition frequencies in the order of 10 MHz will result. The condition is herein that the population inversion in the active medium by four times passage of the radiation beam is not so strongly reduced that a certain “pump time” depending on the pump rate of the respective laser is required in order to newly start the cycle. If the latter is the case, of course the pulse repetition frequency will drop.

The effect of the self-oscillation that is novel and is associated with the special resonator configuration according to the invention, leads thus with continuous pumping to corresponding periodic pulse trains, without an additional power-modulating component having to be integrated in the optical path in the resonator! It is further remarkable that the average power of the “self-oscillating radiation” practically corresponds to the cw value of the laser.

### 4. The Radiation Decoupling Laser—Workpiece.

Beyond the above possibilities of the rapid power modulation, the CO₂ laser according to the invention has another attractive advantage for the practical use in a material processing system.

Frequently, highly reflecting materials have to be processed, in particular metals that reflect or diffract a substantial portion of the incident radiation. Since, in most cases, this radiation is guided by the focussing element in a fairly parallel manner back toward the laser, and can enter through the output coupler element into the resonator, the resonator-internal radiation generation is noticeably disturbed, which results in a deterioration of the beam quality as well as in power variations, in particular for the peak power of pulses. Therefore, it is established state of the art, for a radiation decoupling between laser and workpiece by means of a combination of ATFR mirror, i.e. a polarisation-dependent reflector/absorber, and a λ/4-phase retarder mirror, to build up a kind of “optic diode” that lets the laser radiation pass toward the workpiece, but absorbs returning portions.

If now a CO₂ laser according to the invention is used, the effect of the ATFR mirror is immanently given in the laser in the form of the polarisation beam splitter. As already explained, the beam leaves the laser in a linearly polarised form. When it passes on its way to the workpiece and back two times a λ/4-phase retarder mirror, its plane of polarisation is rotated by 90°, so that it will be deflected automatically from the optical path in the resonator when falling upon the polarisation beam splitter and can be intercepted by an absorber.

Thus, there will be two advantages: First, the component ATFR mirror can be dispensed with and second, the beam portions to be destroyed are not absorbed by the temperature-sensitive component itself—as by the ATFR mirror, but are deflected from the optical path in a desired manner and supplied to a suitable absorber.

### 5. External Power Modulation.

In numerous tasks of laser material processing, the laser power has to be varied during the processing task. In most cases, this occurs by an intervention in the laser process itself, generally by a variation of the pump energy supply. Thereby, however, the beam quality is affected, i.e. the K value will change with the taken-out power, which will result in a reduced processing quality. A solution is offered here by external modulators that allow in a wide range a variation of the power applied to the workpiece, while maintaining the beam quality.

The laser according to the invention, too, has for a certain selected set of parameters, e.g. pulse duration, repetition frequency, and peak power, a defined optimum operational regime in view of best beam quality. Therefore, it is advantageous to perform required power variations by an external modulator that does not influence the laser function itself.

For this purpose, there are inter alia two efficient possibilities, namely acousto-optic and interference laser radiation modulators, which each can be placed close to the laser output and do not disturb further possibly required beam-shaping measures, e.g. the above radiation decoupling laser—workpiece.

For the AOM, it is favourable to use the deflected beam as a processing beam, since its power can be regulated from 0 to a maximum value. The not deflected portion can either be destroyed by an absorber or can e.g. be forwarded to a detector for on-line control of the laser power. If required, beam-shaping elements (telescope, aperture) are to be used for optimum adjustment of the radiation field coming from the laser to the modulator.

The ILM can be integrated in the optical path without such additional elements, since the free diameter of the interferometer plates can be adjusted to the laser radiation without problems. The FPI plates of ZnSe can be loaded with several hundred watts radiation power, without the occurrence of a deterioration of the beam quality in the transmitted beam that typically is used as a processing beam. The not used reflected portion can again either be destroyed by an absorber or be used for on-line control.

It is further noted that it is advantageous to encase the laser according to the invention such that all components directly belonging to the laser are generally protected against external influences, such as dust, air humidity, climate variations. Typically, this is achieved by a design that the complete housing is in direct connection with the active medium, i.e. the components are surrounded by the laser gas. Thereby, their lifetime can be adjusted to the standards being common for lasers.

### BRIEF DESCRIPTION OF THE DRAWINGS

The subject matter of the invention is described in the following with reference to embodiments that are diagrammatically illustrated in the drawings. There are:

FIG. 1: a diagrammatical representation of the CO₂ laser according to the invention,

FIG. 2: a basic arrangement of a λ/4-phase retarder mirror (PRS) as a λ/4-phase shifter,

FIG. 3: the mode of operation of a thin-film polariser based on ZnSe (TFP),

FIG. 4: an arrangement variant with TFP and a transmitted beam as a beam to be coupled out and a reflected beam as a beam to be fed back,

FIG. 5: an arrangement variant of the CO₂ laser according to the invention,

a) a variant with TFP and elements for rapid power modulation,
b) a variant for the implementation of the self-oscillation—first resonator passage,
c) a variant for implementation the self-oscillation—second resonator passage,

FIG. 6: an arrangement variant for rapid power modulation by means of EOM,

FIG. 7: two arrangement variants for rapid power modulation by means of AOM,

a) feedback by means of transmitted beam,
b) feedback by means of deflected beam,

FIG. 8: an arrangement variant for rapid power modulation by means of ILM,

FIG. 9: an arrangement variant for pulse generation by means of chopper disc,

FIG. 10: an arrangement variant for pulse generation by means of tilting mirror,

FIG. 11: radiation decoupling laser—workpiece, arrangement when using a CO₂ laser according to the invention,

FIG. 12: for external power control of the laser radiation,

a) a variant by means of ILM,
b) a variant by means of AOM,

FIG. 13: vacuum-tight encasing at the coupling-out end of the resonator.

### DETAILED DESCRIPTION

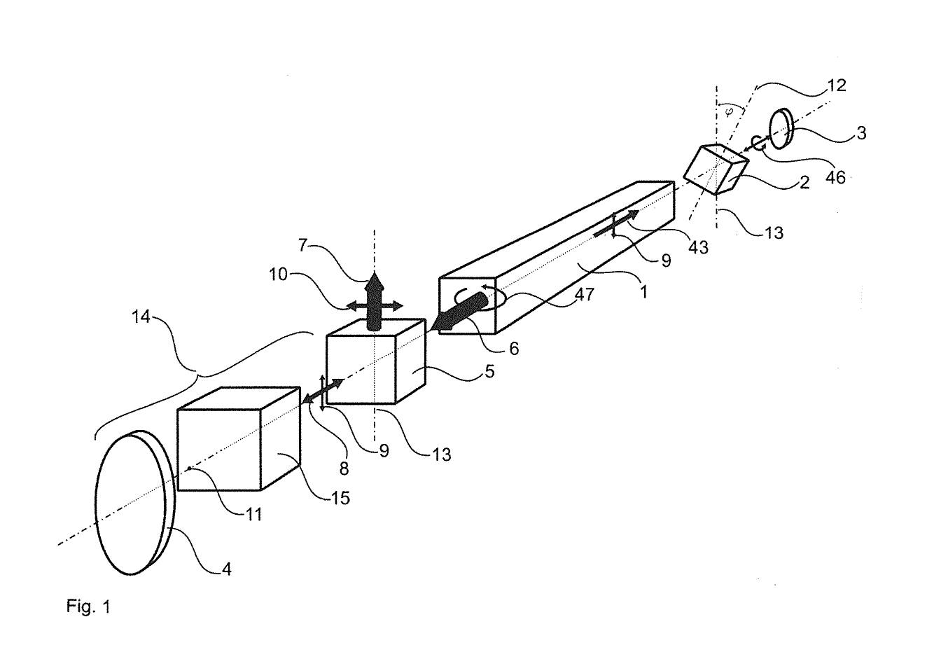

FIG. 1 shows diagrammatically the basic structure of the CO₂ laser according to the invention. First, it does not play a role, which specific geometric conditions are present, in particular in view of the active medium 1. The sketch shows that the resonator is closed at each of both ends by a highly reflecting mirror 3 and 4. By the polarisation beam splitter 5, the resonator is divided into a high-power branch that inter alia contains the active medium 1, and the feedback branch 14 that is characterised by relatively low power. This desired sub-division is achieved by the combination of the polarisation beam splitter 5 and the λ/4-phase shifter 2 at the other end of the resonator in the following manner. When, coming from the direction of the active medium 1, radiation 6 with an initially arbitrary polarisation falls upon the polarisation beam splitter 5, it is sub-divided into two portions linearly polarised in directions perpendicular to each other, one of which is reflected and the other one is transmitted. In FIG. 1, these are the beam 7 to be coupled out having a horizontal polarisation 10 and the beam 8 to be fed back having a vertical polarisation 9. The latter passes, after reflection at the end mirror 4, again through the polarisation beam splitter 5, is amplified in the active medium 1 and travels through the λ/4-phase shifter 2. Depending on which angle φ between a characteristic axis 13 of the polarisation beam splitter 5 and a characteristic axis 12 of the λ/4-phase shifter 2 has now been adjusted, the polarisation condition of the incident wave being linearly vertically polarised may change thereby. In the first special case it remains unchanged, in the second special case it will be circular, in the general case elliptic. After reflection of the wave at the end mirror 3 and a second passage through the λ/4-phase shifter 2, in the second special case, linearly polarised radiation will again be generated, however now with horizontal polarisation, in the general case the elliptic polarisation is maintained, however with a changed proportion of the axes. The relation between the vertical and the horizontal portion of this polarisation ellipse is now decisive for the desired power sub-division at the polarisation beam splitter 5 that finally, after another amplification in the active medium 1, the modified wave reaches again. As already explained, it is a main object of the CO₂ laser according to the invention to keep the power of the beam 8 to be fed back with vertical polarisation 9 as low as possible, without impairing the desired function of the laser. The optimum can easily be found by corresponding adjustment of the angle φ, when the λ/4-phase shifter 2 (what preferably will be done) or the polarisation beam splitter 5 or both are disposed rotatably about the resonator axis 11. Here is found another essential advantage of the solution according to the invention compared to conventional lasers: While with the latter the optimisation of the feedback degree has to be carried out by time-consuming exchange of output coupler elements having different reflectivity, here only the angle φ has to be changed in order to find the optimum of the laser function.

In the feedback branch 14 with optimised relatively low power, now most various elements for beam-shaping 15, in particular elements for rapid power modulation and/or wavelength selection as well as for instance suitable spatial filters for securing the high beam quality of the laser can be integrated. A particular advantage of the arrangement is that e.g. elements with high functionality, but large power sensitivity that in conventional lasers of this power class therefore cannot advantageously be employed, can be used in the CO₂ laser according to the invention without problems.

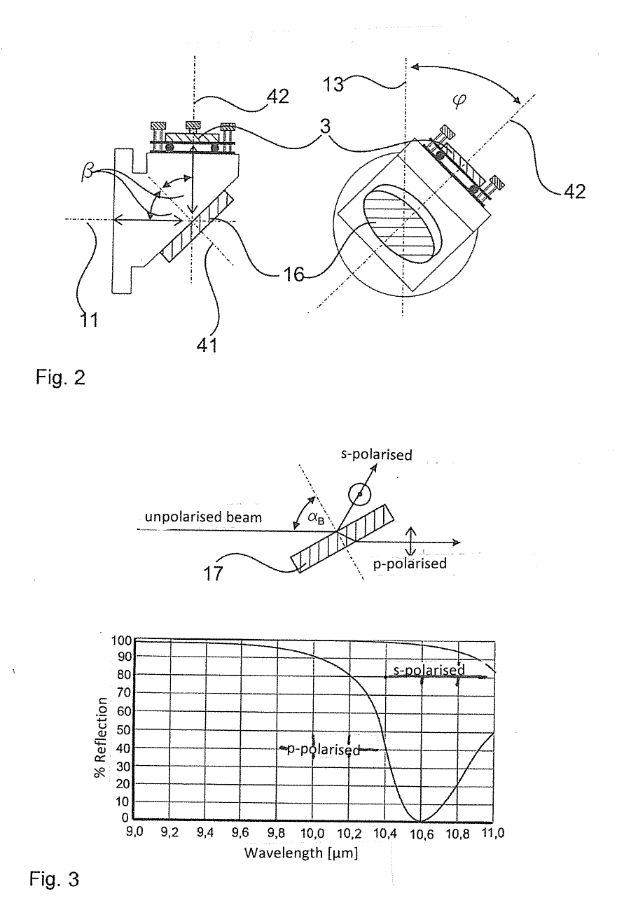

A favourable practical solution for the λ/4-phase shifter 2 is illustrated in FIG. 2, namely the use of a λ/4-phase retarder mirror (PRS) 16. These mirrors are also suitable for high power in the kW range. The left-hand drawing shows a cross-section of its compact arrangement with the adjustable end mirror 3, the right-hand drawing shows the possibility of the rotation of this unit about the resonator axis 11. As is shown in the left-hand drawing, where the drawing plane corresponds to the plane of incidence of the radiation, the relative arrangement of the components has to be selected such that the angle β between the resonator axis 11 and the perpendicular line of incidence 43 of the PRS 16 as well as between the latter and the perpendicular line of incidence 44 of the end mirror 3 is 45°. If it is now assumed that the radiation beam falling upon this unit is linearly polarised in the plane of incidence, i.e. in the drawing plane of the left-hand drawing, it is reflected at both mirrors without changing the polarisation, travels so to speak in an unchanged state back into the active medium. If now, however, as shown in the right-hand drawing, the unit is rotated by an angle φ relative to this initial position, then in the special case φ=45° circularly polarised radiation will result after the first reflection at the PRS 16, and after the reflection at the end mirror 3 and the following second reflection thereat linearly polarised radiation will again result, however polarised in a direction perpendicular to the original direction. For values in the interval 0°<φ<45°, elliptically polarised radiation is obtained.

A decisive feature of the laser according to the invention is that by means of the described unit, linearly polarised radiation coming from the active medium (e.g. perpendicularly polarised as in FIG. 1) is modified by adjustment of a suitable angle φ such that the returning radiation has a desired power ratio between the perpendicularly and the components polarised in parallel.

As a practical solution for the polarisation beam splitter 5, a thin-film polariser (TFP) 17 based on ZnSe can be employed for CO₂ lasers. Its mode of operation is illustrated in FIG. 3. A specially coated ZnSe plate is brought at Brewster's angle α_{B} into the optical path and splits an incident beam of an arbitrary polarisation into a transmitted beam linearly polarised in the plane of incidence, and a reflected beam linearly polarised perpendicularly thereto. As the illustrated dependence of the reflectivity of the TFP 17 on the wavelength for these two beam portions shows, this sub-division is nearly perfect for the main wavelength of the CO₂ laser of 10.59 μm.

In co-operation with the λ/4-phase shifter 2, the TFP 17 permits now the sub-division according to the invention of a beam 6 coming from the direction of the active medium into a high-power beam 7 to be coupled out (power P_{A}) and a relatively low-power beam 8 to be fed back (power P_{R}). In real CO₂ lasers of high power for material processing, often a few percent of the incident radiation are sufficient for an efficient feedback, so that power ratios P_{A}/P_{R} of 10 and more are applicable, i.e. the radiation loading capacity of the elements for beam-shaping that can be integrated in the feedback branch 14, is extremely low. As already described, this ratio can easily be adjusted and optimised by the angle φ.

The beam sub-division at the TFP 17 can be made in principle in two ways. Either the reflected beam is coupled out and the transmitted beam is used for feedback, or vice versa. Both variants have advantages and disadvantages that mainly result from two properties of the TFP 17: First, the absorption for the p component is substantially higher than for the s component of the radiation, and second, as shows FIG. 3, the reflectivity for the p component is strongly wavelength-dependent.

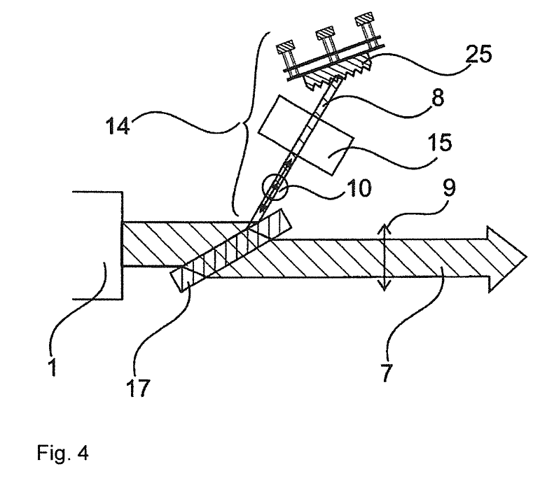

If now the reflected beam is coupled out, and the transmitted beam is fed back, there are two advantages in that, first, the strong power portion is reflected as the s component right at the front side of the TFP 17 and suffers only minimum absorption losses, and, second, the 2-dependence of the transmitted p component being responsible for the feedback even has an effect stabilising the function of the laser. A certain disadvantage is the two times passage of the beam to be fed back as the p component, i.e. with relatively high absorption, by the TFP 17 with the risk of a distortion of the resonator-internal wavefront. This problem disappears, when the reflected portion is fed back. However, two other problems occur instead, namely the risk of a substantial influence on the divergence of the intense coupled-out beam 7 by a “thermal lens” in the TFP 17 and by the wavelength dependence of the p component that requires, for avoiding the excitation of undesired laser lines, an additional wavelength selection in the feedback branch 14. The latter variant is shown in FIG. 4 with a grating mirror 25 as a wavelength-selective element.

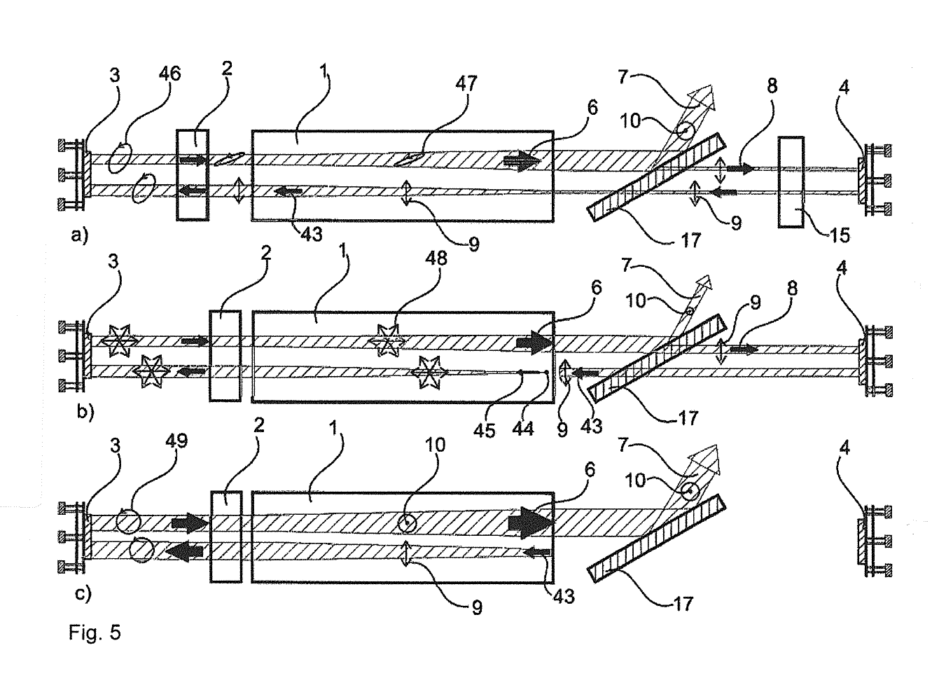

The version that is used more frequently will be the one shown in FIG. 5, wherein the reflected beam is coupled out. FIG. 5a) illustrates the most important case with the TFP 17 as a beam splitter and elements 15 for power modulation in the feedback branch 14, as well as the typical polarisation conditions. The returning radiation beam 43 with linear perpendicular polarisation 9 is transformed at the λ/4-phase shifter 2 during the first passage into radiation with weakly elliptical polarisation 46 and after reflection at the end mirror 3 during the second passage into radiation with strongly elliptical polarisation 47, the main polarisation component of which is horizontal, so that the beam 6 amplified in the active medium 1 is split at the TFP 17 into the strong beam 7 to be coupled out and being reflected as the s component and the weak beam 8 being transmitted as the p component. The latter passes two times through the beam-shaping, in particular power-modulating elements 15, subsequently passes without further power losses through the TFP 17, and travels back again as a returning radiation beam 43 with linear perpendicular polarisation 9 through the active medium 1.

FIGS. 5b) and c) illustrate the special case of the self-oscillation. For better understanding the effect, the representation was divided into the first resonator passage (5b)) and the second resonator passage (5c)), which together correspond to one period of the self-oscillation. In FIG. 5b), a particular radiation beam 45 starts at point 44, said beam initially consisting exclusively of those spontaneously emitted photons that travel exactly in the direction of the resonator axis 11. This unpolarised (48) beam is amplified in the active medium 1, travels two times through the λ/4-phase shifter 2 and finally reaches after another amplification as a still unpolarised beam 6 the TFP 17. The latter now splits it into two equally large portions 7 and 8 that in the shown manner are each linearly polarised. The beam 8 is fed back, and after reaching point 44, the first round trip is completed.

The now already relatively strong beam 8 with the linear polarisation 9 reaches after another amplification the λ/4-phase shifter 2, which is exactly adjusted (by the angle φ) such that the beam after the first passage has an exactly circular polarisation 49 and consequently, after reflection at the end mirror 3 and the second passage, is again polarised linearly, but now horizontally (10). This beam reaches, after another amplification, the TFP 17 and is now completely reflected, i.e. coupled out. The feedback is 0, the shown process must re-start again, i.e. the pulse repetition frequency of the self-oscillation is in principle predetermined by a two times round trip through the resonator. The exact time/power course in the coupled-out radiation beam 7 depends in a complex manner on the laser parameters and can only be determined by solving the balance equations or of course by experiments.

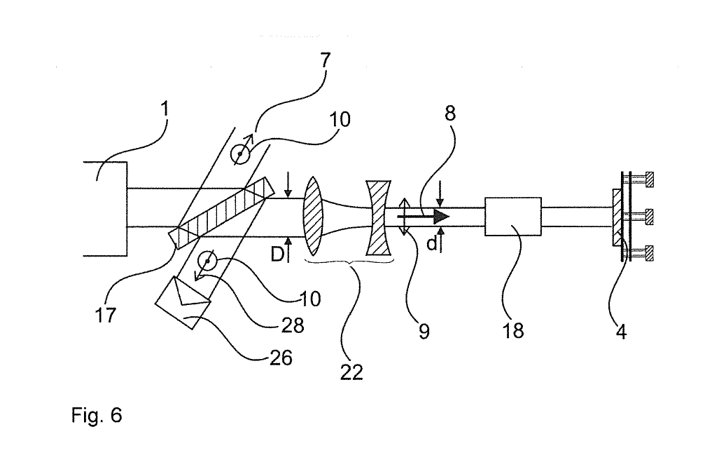

Out of the great variety of possible arrangement variants of the CO₂ laser according to the invention, FIGS. 6 to 10 show characteristic examples.

First, in FIG. 6, an EOM 18 is integrated in the feedback branch 14 of the resonator. The use of such modulators is problematic for the large wavelengths of the CO₂ laser, relatively small and expensive switching crystals must be used, e.g. of CdTe, which require high switching voltages and are not ideal with respect to their optical parameters (radiation loading capacity and absorption). A positive feature is however their extremely high switching speed that makes their use desirable. Compared to conventional CO₂ lasers, the laser according to the invention offers significant advantages, which solve the cited problems. First, the power in the feedback branch 14, even with comparatively high average powers in the beam 7 to be coupled out, can be reduced such that e.g. by using a telescope of Galileo's type 22 the diameter D of the beam 8 to be fed back can be adjusted to the free opening d of the small switching crystals 18, without a destruction of the crystal by the higher power density having to be expected. Second, with the TFP 17, the polarisation-selective element, which is required for the modulation by means of electro-optic crystals, is already immanently included in the resonator, i.e. needs not be integrated additionally. For completely switching off the feedback, the application of a quarter-wave voltage at the modulator in sufficient, in order to rotate the polarisation of the beam 8 to be fed back by 90°, so that when returning from the TFP 17 it is completely reflected as a beam 28 and is destroyed by the absorber 26.

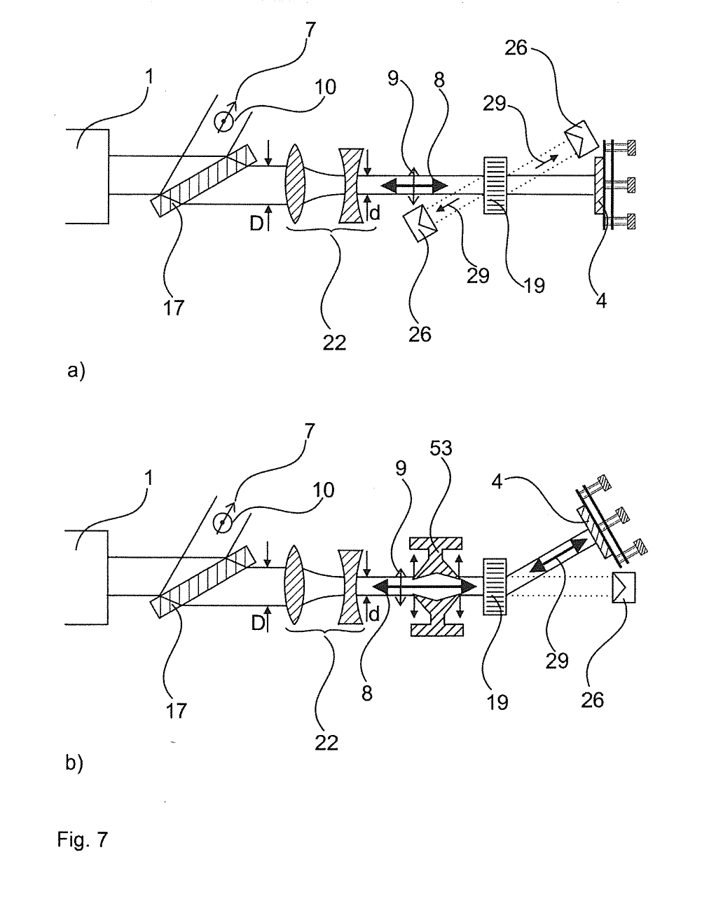

FIG. 7 shows a similar arrangement, however with the AOM 19. Since the switching speed depends inter alia on the free diameter d (small d—high switching speed), these modulators are generally available only with d<10 mm, so that here, too, in most cases the integration of a telescope of Galileo's type 22 is required. Since Germanium, which is used as the acousto-optic crystal in CO₂ lasers, also responds relatively sensitively to high intensities, again the low power in the feedback branch is the decisive advantage of the laser according to the invention.

FIG. 7 shows two variants of the AOM use. In FIG. 7a), the feedback, i.e. the condition, in which the laser operates, occurs via the beam directly passing through the AOM 19 without control signal toward the end mirror 4. When applying a control signal, i.e. generating a refractive index grating in the modulator, the beams travelling to and fro are deflected to a higher or lower degree depending on the control signal, out of the optical path in the resonator (beams 29). Thereby it is possible to modulate the feedback and consequently the laser output power. With sufficiently high diffraction losses that are taken up by the absorbers 26, the laser can be brought below its threshold and thus can completely be switched off—a proper pulse operation is possible.

In the second variant shown in FIG. 7b), the beam 29 deflected by the modulator when applying a control signal is used for feedback. Herein, it is clear that with control signal=0, feedback is also 0, i.e. the laser is switched off. Thus, even lasers having very high gains that are excited already at very small feedbacks, can properly be pulsed. Another positive aspect of this arrangement is the wavelength selectivity that is immanent to the diffraction process. So, if applicable, other wavelength-selective elements in the optical path in the resonator can be dispensed with. For securing the high beam quality and for eliminating a potential influence on the transversal mode structure of the laser by undesired diffraction effects in the edge area of the AOM, a special aperture 53 can be placed as a suitable spatial filter between the telescope 22 and the modulator 19.

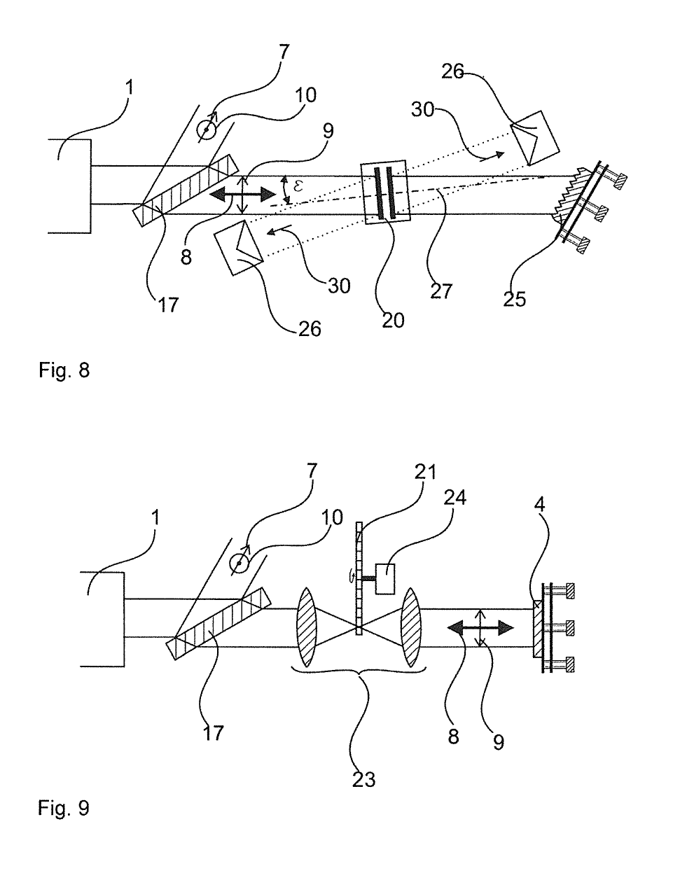

FIG. 8 illustrates the use of ILM 20 for rapid power control of the CO₂ laser according to the invention. In the shown arrangement, the laser operates, when the modulator is adjusted, in the ideal case, to transmission=1 and the beam 8 to be fed back can pass quasi free of loss. When a corresponding control current is applied, the distance of the interferometer plates is varied, and more or less intense reflected radiation portions 30 occur, which are again destroyed by absorbers 26. Due to T=1−R, the transmitted portion decreases to an analogous degree and thus the feedback decreases, too, the output power of the laser can be modulated or also switched off, and thus pulse operation can be obtained.

The described scenario operates properly only if the laser is forced to operate exactly on one wavelength. For this purpose, a wavelength-selective element is required—this is in FIG. 8 the diffraction grating 25 that replaces at the same time the end mirror 4.

ILMs, too, respond relatively sensitively to high powers, since the two interferometer plates can noticeably influence with high loads the transmitted wavefronts. Consequently, the low radiation loading capacity in the feedback branch 14 is a relevant factor here, too.

Another variant that is not as flexible as the above variants, however is on the other hand very simple and cost-effective, is shown in FIG. 9. By means of a rapidly rotating chopper disc 21, which is driven by a controllable motor 24 and at least the speed of which can easily be regulated, the beam 8 to be fed back is periodically switched on and off. In order that particularly the switching-on process occurs as rapidly as possible in the μs range and leads to a real Q-switching effect with a strong power increase, the beam 8 to be fed back is not “chopped” at its original diameter, but in the intermediate focus of a telescope 23 of the Keplerian type. Further elements are in principle not required. Again the advantage of the low power in the feedback branch 14 in this system is that, despite the sharp focussing in the telescope, there is, even with the generation of very high-power pulses, no sparking at the switching edge, and thus no material erosion occurs that would substantially reduce the lifetime of the chopper disc 21.

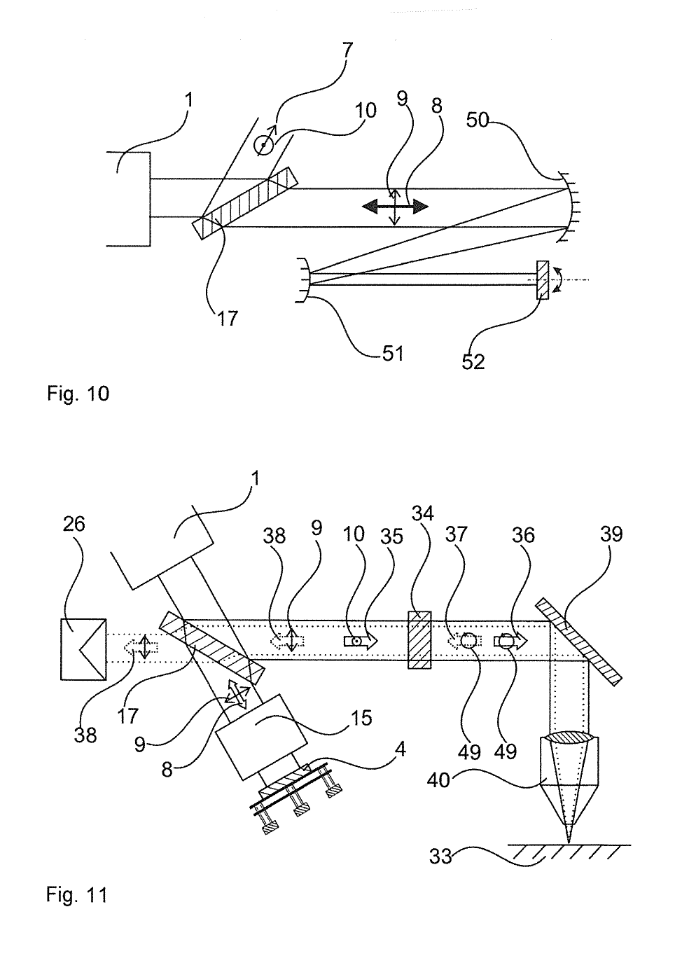

A variant that is of interest by the development of modern high-power scanner systems, is illustrated in FIG. 10. In order to show at the same time, how the telescopes based on lenses can be replaced by mirror versions, here a Galileo's-type telescope comprising a concave mirror 50 and a convex mirror 51 is used. The radiation beam 8 having its diameter reduced by this telescope falls upon the tilting mirror 52 replacing the end mirror 4. By rapid oscillation of this tilting mirror 52, the laser resonator can quickly be switched between adjusted and unadjusted condition and back, and in this way radiation pulses can be generated. The achievable pulse repetition frequencies are in the order of 10⁴ Hz. Since this pulse repetition frequency depends on the mass of the tilting mirror 52 and thus on its diameter, the reduction of the beam diameter is reasonable. Here, too, the low power in the feedback branch 14 is extremely advantageous, since very small mirror diameters in the order of mm and thus very high pulse repetition frequencies can be used without the risk of destroying the mirror.

The advantages of the CO₂ laser according to the invention are not only limited to the radiation properties of the laser itself. FIG. 11 shows a significant advantage that this laser offers when using it in a material processing system. For such systems, it is typical that on the one hand not linearly, but circularly polarised radiation 36 is sent onto the workpiece 33, and on the other hand measures for radiation decoupling between laser and workpiece are taken, in order that the radiation 37 returning e.g. from highly reflecting materials toward the laser will not lead to instabilities during the process of the radiation generation in the laser. In conventional systems, for this purpose two components are used in combination, an ATFR mirror that reflects the s-polarised radiation and absorbs the p-polarised radiation, and a λ/4-phase shifter 34. When the CO₂ laser according to the invention is used, the ATFR mirror can be dispensed with, since its task can automatically be taken by the polarisation beam splitter, in FIG. 11 that is the TFP 17. For, after two times passage of the external λ/4-phase shifter 34, the radiation beam 38 coming from the workpiece 33 is linearly polarised, however in a direction perpendicular to the laser radiation 35, and consequently is completely passes through the TFP 17, i.e. is eliminated from the optical path in the resonator. An absorber 26 will destroy this radiation.

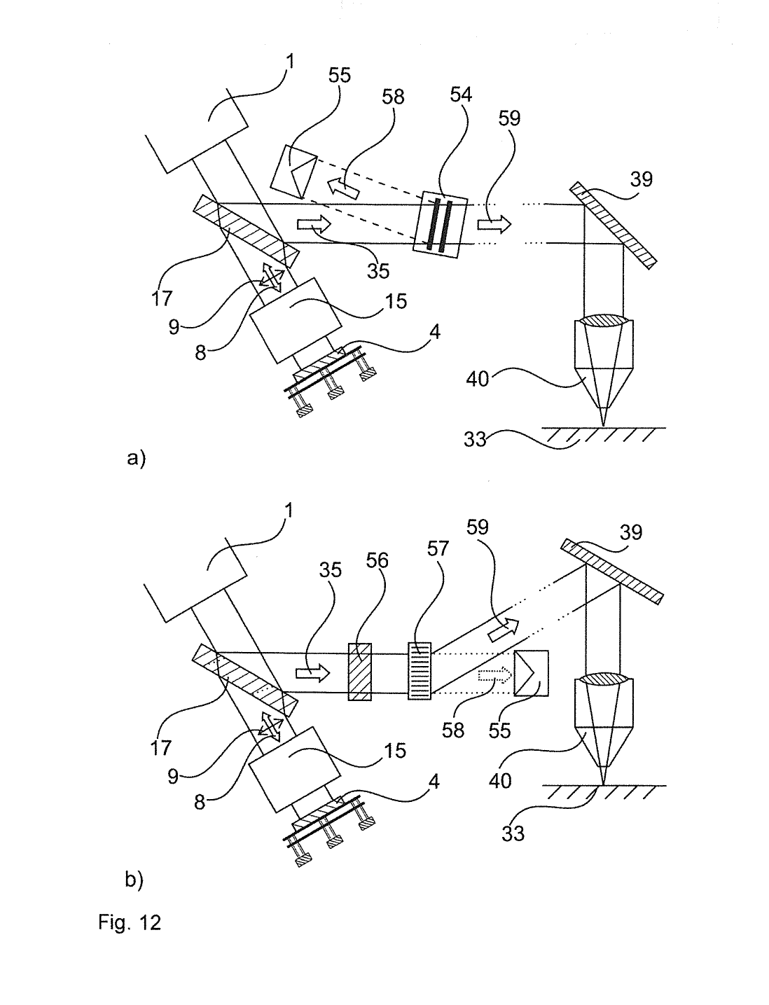

During real material processing tasks, in most cases a variation of the laser power is required. In order to not affect optimally adjusted parameters of the laser function itself, in particular the quality of the laser radiation, an external power modulation is advantageous. FIG. 12 illustrates two possibilities that can be used in conjunction with the CO₂ laser according to the invention for this purpose. In FIG. 12 a), the use of an ILM 54 for external power modulation is shown. The beam 35 coming from the laser is sub-divided by the ILM 54 into the transmitted beam 59 with controlled power that is supplied to the workpiece 33, and into the reflected beam 58 with the remaining power. The latter is either destroyed in the component 55 that optionally may be an absorber or a radiation detector, or can be used for on-line monitoring. The advantage of using the ILM resides in its relatively high radiation loading capacity, the modulation speed is however limited to typical times in the range 10 to 100 μs. The achievable maximum-minimum modulation range of the power depends on the employed interferometer plates. Typical ILM models allow attenuations of the laser beam 35 by factors between 10 and 100.

Very high modulation speeds up to the sub-μs range are permitted by using an AOM 57 as shown in FIG. 12 b), wherein generally optical elements for beam-shaping 56, e.g. a telescope for adjusting the beam diameter and a special aperture for securing the beam quality, are connected upstream. In this example, the deflected beam is supplied to the workpiece 33 as a power-controlled beam 59. The remaining beam 58 is again optionally destroyed in an absorber/detector 55 or is measured. Another advantage of this arrangement is the fact that the beam 59 can arbitrarily strongly be attenuated, as a minimum down to 0 W. Depending on the AOM model, the controllable power is however limited.

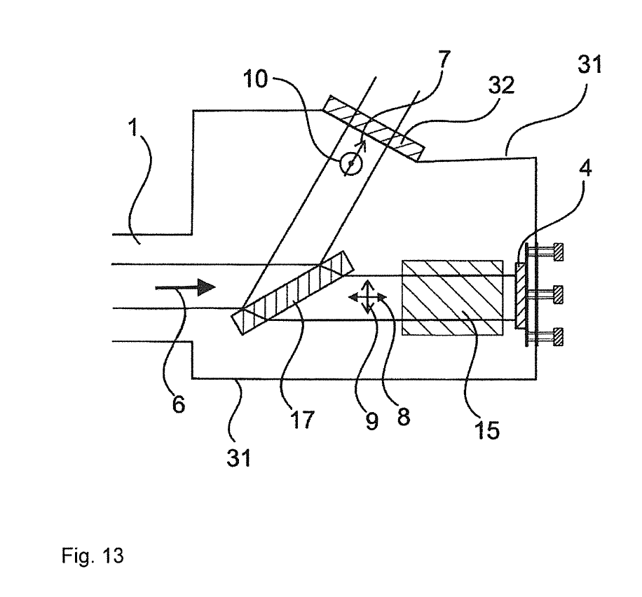

FIG. 13 shows very diagrammatically an important factor for the practical implementation of the CO₂ laser according to the invention. In order to assure the long-term stability of the sensitive resonator-internal components, in particular to protect them from dust and climate variations, the whole system should be accommodated in a vacuum-tight housing 31.

FIG. 12 shows this for the laser end with the thin-film polariser 17 and the elements of the feedback branch 14. The beam 7 to be coupled out leaves the laser through the window 32 of transparent material, preferably of ZnSe. In an analogous manner, the elements at the other end of the resonator, i.e. the λ/4-phase retarder mirror 16 and the end mirror 3, have to be included in the housing. In a practical manner, the whole vacuum-tight housing 31 may be connected with the volume of the active medium 1.

1. A CO₂ laser comprising:
a resonator closed at both ends by resonator end mirrors and containing an active medium, and comprising electrodes for a pump energy supply,
wherein the resonator is sub-divided along a resonator axis extending perpendicularly to the resonator end mirrors, between the resonator end mirrors into a high-power branch and a feedback path,
wherein the high-power branch and the feedback branch are separated from one another by a polarisation beam splitter for coupling out part of a laser beam generated in the resonator,
wherein in the high-power branch between a first of the resonator end mirrors and the polarisation beam splitter the active medium and a λ/4-phase shifter is disposed,
wherein in the feedback branch between a second of the resonator end mirrors and the polarisation beam splitter elements for beam-shaping are disposed,
wherein the λ/4-phase shifter and the polarisation beam splitter are arranged to be turned with respect to one another by an angle φ, and that about an axis of rotation having at least one component of rotation in parallel to the resonator axis or about the resonator axis,
wherein the resonator axis extends either in a straight line or in a bent line through the polarisation beam splitter, and
wherein the second resonator end mirror is replacable by a wavelength-selective element as an element for beam-shaping.

2. The CO₂ laser according to claim 1, wherein the active medium in the resonator, has a pressure of less than 0.2 bar.

3. The CO₂ laser according to claim 1, wherein both resonator end mirrors have a reflectivity of more than 95.

4. The CO₂ laser according to claim 1, wherein the elements for beam shaping are selected from the group comprising elements for power modulation, for wavelength selection, special apertures, and combinations of 2 or more such elements.

5. The CO₂ laser according to claim 1, wherein the λ/4-phase shifter is a λ/4-phase retarder mirror.

6. The CO₂ laser according to claim 1,
wherein the angle φ is adjustable with the proviso that the beam travelling through the active medium toward the polarisation beam splitter and the beam travelling toward the λ/4-phase shifter are each linearly polarised in directions perpendicular to each other, or
wherein the beam reflected from the polarisation beam splitter is used as a beam to be coupled out, and the transmitted beam is used as a beam to be fed back, and wherein the resonator axis extends in a straight line through the polarisation beam splitter.

7. The CO₂ laser according to claim 1, wherein the beam transmitted by the polarisation beam splitter is used as a beam to be coupled out, and the reflected beam is used as a beam to be fed back, and wherein the resonator axis extends in a bent line through the polarisation beam splitter.

8. The CO₂ laser according to claim 1, wherein in the feedback branch of the resonator a diffraction grating is used as a wavelength-selective element in lieu of the second resonator end mirror.

9. A material processing system comprising: a workpiece holder for a workpiece and a CO₂ laser according to claim 1, wherein the workpiece is positionable with the workpiece holder relative to a laser output of the laser, wherein in the beam path between the laser output and the workpiece a λ/4-phase shifter is provided with the proviso that the linearly polarised radiation of the laser is transformed into circularly polarised radiation, a radiation portion, after reflection or scattering at the workpiece, travelling back toward the laser after the second passage of the λ/4-phase shifter is again linearly polarised in a direction perpendicular to the emitted laser radiation, and that this radiation portion, before entering into the active medium in the resonator, is deflected by the polarisation beam splitter from the direction of the laser beam, and is destroyed by an absorber.

10. A material processing system comprising: a workpiece holder for a workpiece and a CO₂ laser according to claim 1, wherein the workpiece is positionable with the workpiece holder relative to a laser output of the laser, wherein in the beam path between the laser output and the workpiece, elements for power modulation are integrated with the proviso that the power of the beam travelling toward the workpiece is adjustable in a wide range, without control parameters in the laser being changed.

11. The CO₂ laser according to claim 1, wherein the λ/4-phase shifter is disposed between the active medium and the first resonator end mirror.

12. The CO₂ laser according to claim 1 wherein the angle φ is adjustable with the proviso that the beam travelling through the active medium toward the λ/4-phase shifter and the beam travelling through the active medium toward the polarisation beam splitter is elliptically polarised, the eccentricity and the location of the ellipse being determined by φ,
wherein the beam reflected from the polarisation beam splitter is used as a beam to be coupled out, and the transmitted beam is used as a beam to be fed back, and wherein the resonator axis extends in a straight line through the polarisation beam splitter.
